(19) United States
(12) Patent Application Publication
(10) Pub. No.: US 2008/0018140 A1
(43) Pub. Date: Jan. 24, 2008

(54) Safety Device For A Motor Vehicle

(75) Inventors: Dominic Reutter, Birenbach (DE); Hans-Herbert Schreier, Ueberlingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler, Stuttgart (DE)

(21) Appl. No.: 10/591,667

(22) PCT Filed: Feb. 26, 2005
(86) PCT No.: PCT/EP05/02061

§ 371 Date: Jun. 5, 2007

(30) Foreign Application Priority Data
Mar. 4, 2004 (DE) 10 2004 010 544.8

(51) Int. Cl. B60J 7/053; E05F 15/20; H02P 1/00

(52) U.S. Cl. 296/221; 318/277; 49/31

(57) ABSTRACT

A safety device is provided for a motor vehicle with a tilting roof integrated into a roof area and a servo drive for opening and closing the tilting roof. A coordination unit is provided that evaluates data relevant to driving safety and controls the servo drive in a timed manner so that a closing operation is initiated for the open tilting roof prior to an imminent accident.

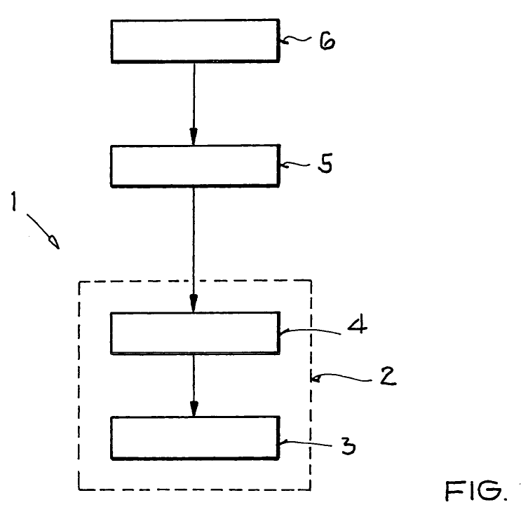

This application is a National Phase of PCT/EP2005/002061, filed Feb. 26, 2005, and claims the priority of DE 10 2004 010 544.8, filed Mar. 4, 2004, the disclosures of which are expressly incorporated by reference herein.

The invention relates to a safety device for a motor vehicle with a tilting roof integrated into a roof area.

DE 101 21 386 C1 discloses a method for controlling a reversible occupant protection means in a motor vehicle with a sensor system for acquiring driving conditions data. Emergency braking, over-and-understeer of the motor vehicle are monitored as driving conditions data. The occupant protections means is triggered relative to one such condition. From the driving conditions data, the direction from which the maximum danger is to be expected can also be determined. The occupant protection means is controlled so that the protective effect is implemented corresponding to the direction of maximum danger.

DE 44 11 184 C2 describes a belt restraint system for a seat in a vehicle with a seat belt and a belt tensioner for securing a passenger to the seat. The distance to an object and the corresponding relative speed can be determined by a device. From this, the anticipated time until a possible collision between the vehicle and the object can be determined. A control unit generates a control signal that increases the force of the belt tensioner at an appropriate time before the possible collision. If a collision can be avoided, the force of the belt tensioner is again reduced. The controlled belt tensioner is designed as a pre-tensioner that is effective only up to a certain preset pre-tension before the collision, with a further belt tensioner being triggered for an increased tightening of the seat belt, if the collision is actually detected.

Furthermore DE 34 24 334 A1 discloses a slide and tilt roof for a motor vehicle with an optional raised ventilation position from its closed position flush with the roof level, or an adjustable rigid sliding roof with a lowered slid-open position opening a section of the roof. The sliding roof can be raised at its rear edge from its closed position to the ventilation position by a hinged lever in conjunction with guides laid along the roof cut-out, or can be lowered into the sliding position.

Furthermore, DE 40 31 552 A1 describes a safety device for a vehicle the interior of which has at least one opening, for example a side window, that by way of a closure element connected to a servo drive can be closed or opened as required. A sensor system detects the vehicle deceleration in the direction of travel and triggers the closing movement of the closure element if a preset value for the vehicle deceleration is overshot. With a suitable choice of the preset value for the vehicle deceleration, the opening can be closed even before the vehicle strikes an obstacle. When the actual accident occurs, the occupants are protected against injury from foreign bodies entering the vehicle from outside through the opening. The ejection of occupants from the vehicle through the opening can also be avoided. A tilting roof integrated into the roof area of the vehicle would protect vehicle occupants from foreign bodies from outside and prevent unintentional ejection of the occupants from the vehicle in both the open and closed conditions.

According to the present invention, a control unit evaluates the data relevant to driving safety and controls the servo drive in a timed manner such that a closing operation is initiated for the open tilting roof prior to an imminent accident. The safety device for the motor vehicle includes the tilting roof integrated into the roof area and the servo drive for opening and closing the tilting roof

Furthermore, it is advantageous if the tilting roof is already closed prior to the imminent accident. A timely closure of the tilting roof before the actual occurrence of the accident avoids the hinged lever of the tilting roof being pushed down or sheared off during the accident, for example if the vehicle overturns. In a particularly unfavorable situation, the tilting roof could even be completely ripped off, which would mean that foreign bodies from outside could enter the vehicle through the opening thus produced in the vehicle roof and occupants could be ejected from the vehicle. The time immediately before the accident is used to initiate preventive measures for improving the safety of the occupants. Preventive occupant protection is guaranteed by the preventive-action safety device.

In an embodiment of the invention, the tilting roof also has a sliding function for opening and closing parallel to the roof plane. Closure elements in the roof area are frequently fitted with a sliding and tilting function, that sometimes can also be activated at the same time. This ensures that the tilting roof is also closed from an open position to which it has been slid prior to the actual accident.

The data relevant to driving safety can especially be driving conditions variables. Variables such as vehicle speed, yaw acceleration, longitudinal acceleration, transversal acceleration, brake pedal and accelerator pedal positions and the steering angle are used as driving conditions variables. Furthermore, the status of controls and indicators such as turn indicators and hazard warning lights and the status of sensors and control units of relevance to the vehicle can also be used as driving conditions variables.

As an alternative or in addition, the data relevant to driving safety can be environmental data. Environmental data is data provided by environmental sensors, telematic systems and by communication between the motor vehicle and other motor vehicles or stationery communication systems. Examples of environmental data are information on the actual location, type of road and lane on which the actual motor vehicle is traveling. Other environmental data includes road conditions, temperature, weather, lighting conditions and speed, distance, type and size of motor vehicles in front, alongside, following or oncoming and of other road users.

It is advantageous if the data relevant to driving safety is evaluated driver actions. An evaluation of driver actions includes, for example, detection of the driver's eye movement, the direction of sight and also includes operation of controls such as steering wheel, gear selector lever and brake pedal. By evaluating various safety-relevant data, the correct time point for closing the tilting roof when needed can be determined by means of the coordination unit.

Other objects, advantages and novel features of the present invention will become apparent from the following detailed description of the invention when considered in conjunction with the accompanying drawings.

### BRIEF DESCRIPTION OF THE DRAWING

The single FIGURE is a block diagram showing a section from a safety device for a motor vehicle with a tilting roof integrated into a roof area.

### DETAILED DESCRIPTION OF THE DRAWING

A safety device 1 for a motor vehicle includes a tilting roof 3 integrated into a roof area 2 and a servo drive 4 for opening and closing the tilting roof 3.

A control units evaluates the data relevant to driving safety 6 and controls the servo drive 4 in a timed manner, in such a way that a closing operation is initiated for the open tilting roof 3 prior to an imminent accident. In this case it is advantageous if the tilting roof 3 is already closed prior to the imminent accident. The servo drive 4 can also have a quick-closing function that is initiated when the servo drive 4 is activated by the control unit 5. The quick-closing function of the servo drive 4 ensures that the tilting roof 3 is also closed in time prior to the actual accident. The quick-closing function can also be realized in a specially designed servo drive 4. If the accident does not occur, the tilting roof 3 is re-opened.

The tilting roof 3 can also have a sliding function parallel to the roof plane for opening and closing. If the tilting roof 3 is in an open position the open tilting roof 3 is also moved to the closed position by means of a preventative closing operation.

The data relevant for driving safety 6 includes driving conditions variables, environmental data and/or evaluated driver actions.

The safety device 1 according to the invention for the motor vehicle with the tilting roof 3 integrated into the roof area 2 guarantees that in the event of an accident the tilting roof 3 is not damaged and its functions are thus not impaired, for example by it being torn off. The tilting roof 3, for example, guarantees that the occupants of the motor vehicle are also reliably protected during the accident from the penetration of objects from the environment of the vehicle into the vehicle itself.

1-8. (canceled)

9: A safety device for a motor vehicle with a tilting roof integrated into a roof area and a servo drive for opening and closing the tilting roof, comprising a control unit configured to evaluate the data relevant to driving safety and to control the servo drive in a timed manner such that a closing operation is initiated for the open tilting roof prior to an imminent accident.

10: The safety device as claimed in claim 9, wherein the tilting roof is closed prior to the imminent accident.

11: The safety device as claimed in claim 9, wherein the tilting roof has a sliding function for opening and closing parallel to a plane of the roof.

12: The safety device as claimed in claim 9, wherein the servo drive is operative to have a quick-closing function initiated when the servo drive is activated by the control unit.

13: The safety device as claimed in claim 9, wherein the data relevant to driving safety comprises driving conditions variables.

14: The safety device as claimed in claim 9, wherein the data relevant to driving safety comprise environmental data.

15: The safety device as claimed in claim 9, wherein the data relevant to driving safety comprise evaluated driver actions.

16: The safety device as claimed in claim 9, wherein the tilting roof is arranged not to re-open if the imminent accident does not occur.
